(19) United States
(12) Patent Application Publication
(10) Pub. No.: US 2013/0183981 A1
(43) Pub. Date: Jul. 18, 2013

(54) METHODS AND APPARATUS FOR IMPROVING CELL REDIRECTION SEARCH TIME

(71) Applicant: QUALCOMM INCORPORATED, San Diego, CA (US)

(72) Inventors: Sumit Kumar Singh, San Diego, CA (US); Bhupesh Manoharlal Umatt, Poway, CA (US); Sathish Krishnamoorthy, Hyderabad (IN); Thomas Klingenbrunn, San Diego, CA (US); Shyamal Ramachandran, San Diego, CA (US); Krishna Rao Mandadapu, San Diego, CA (US); Nitin Pant, San Diego, CA (US)

(73) Assignee: QUALCOMM INCORPORATED, San Diego, CA (US)

(21) Appl. No.: 13/744,105

(22) Filed: Jan. 17, 2013

Related U.S. Application Data
(60) Provisional application No. 61/588,092, filed on Jan. 18, 2012.

(51) Int. Cl. H04W 36/00

(52) U.S. Cl. CPC H04W 36/0016
USPC 455/437

(57) ABSTRACT

Aspects of the present disclosure provides methods, corresponding apparatus and program products, for improving LTE to another network (e.g., Wideband Code Division Multiple Access, WCDMA) redirection search time. A user equipment (UE) may receive a redirection message indicating a frequency for a potential target cell and may attempt to acquire a target cell based on the frequency indicated in the redirection message. IF the UE's attempt to acquire a target cell based on the indicated frequency fails to find a suitable target cell, the UE may attempt to find a suitable target cell using a heuristic approach involving one or more frequencies different than the frequency indicated in the redirection message.

### CLAIM OF PRIORITY UNDER 35 U.S.C. §119

The present Application for Patent claims priority to U.S. Provisional Application No. 61/588,092 entitled, “METHOD AND APPARATUS FOR IMPROVING CELL REDIRECTION SEARCH TIME,” filed Jan. 18, 2012, and assigned to the assignee hereof and hereby expressly incorporated by reference herein.

### FIELD

Aspects of the present disclosure relate generally to wireless communications, and more particularly, to methods and apparatus for improving LTE to another network (e.g., Wideband Code Division Multiple Access, WCDMA) redirection search time.

### BACKGROUND

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include code division multiple access (CDMA) networks, time division multiple access (TDMA) networks, frequency division multiple access (FDMA) networks, orthogonal FDMA (OFDMA) networks, and single-carrier FDMA (SC-FDMA) networks.

A user equipment (UE) may be located within the coverage of multiple wireless networks, which may support different communication services. A suitable wireless network may be selected to serve the UE based on one or more criteria. The selected wireless network may be unable to provide a desired communication service (e.g., voice service) for the UE. A set of procedures may then be performed to redirect the UE to another wireless network (e.g., 2G, 3G or non-LTE 4G) that can provide the desired communication service.

### SUMMARY

Aspects of the present disclosure provide methods, corresponding apparatus and program products, for cell reselection.

Certain aspects of the present disclosure provide a method for wireless communications by a user equipment (UE). The method generally includes receiving a redirection message indicating a frequency for a potential target cell, attempting to acquire a target cell based on the frequency indicated in the redirection message, and if the attempt to acquire a target cell based on the indicated frequency fails to find a suitable target cell, attempting to find a suitable target cell using a heuristic approach involving one or more frequencies different than the frequency indicated in the redirection message.

Certain aspects of the present disclosure provide an apparatus for wireless communications by a user equipment (UE). The apparatus generally includes means for receiving a redirection message indicating a frequency for a potential target cell, means for attempting to acquire a target cell based on the frequency indicated in the redirection message, and means for attempting to find a suitable target cell using a heuristic approach involving one or more frequencies different than the frequency indicated in the redirection message, if the attempt to acquire a target cell based on the indicated frequency fails to find a suitable target cell.

Certain aspects of the present disclosure provide an apparatus for wireless communications by a user equipment (UE). The apparatus generally includes at least one processor configured to receive a redirection message indicating a frequency for a potential target cell, attempt to acquire a target cell based on the frequency indicated in the redirection message, and if the attempt to acquire a target cell based on the indicated frequency fails to find a suitable target cell, attempt to find a suitable target cell using a heuristic approach involving one or more frequencies different than the frequency indicated in the redirection message; and a memory coupled with the at least one processor.

Certain aspects of the present disclosure provide computer program product for wireless communication by a user equipment (UE), comprising a computer readable medium having instructions stored thereon. The instructions are generally executable by one or more processors for. The method generally includes receiving a redirection message indicating a frequency for a potential target cell, attempting to acquire a target cell based on the frequency indicated in the redirection message, and if the attempt to acquire a target cell based on the indicated frequency fails to find a suitable target cell, attempting to find a suitable target cell using a heuristic approach involving one or more frequencies different than the frequency indicated in the redirection message.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary deployment in which multiple wireless networks have overlapping coverage.

FIG. 2 illustrates a block diagram of a user equipment (UE) and other network entities.

FIG. 3 illustrates an example call flow of circuit-switched fallback (CSFB) when a UE makes a mobile originating (MO) call, according to certain aspects of the present disclosure.

FIG. 4 illustrates an example call flow of CSFB when a UE receives a mobile terminating (MT) call, according to certain aspects of the present disclosure.

FIG. 5 illustrates example operations 500 that may be performed to improve cell redirection search time, in accordance with certain aspects of the present disclosure.

FIG. 6 illustrates example operations 600 that may be performed to improve cell redirection search time, in accordance with certain aspects of the present disclosure.

### DETAILED DESCRIPTION

Circuit-switched fallback (CSFB) is a technique to deliver voice-services to a mobile, when the mobile is camped in a long-term evolution (LTE) network. This may be required when the LTE network does not support voice services natively. The LTE network and a 3GPP CS network (e.g., UMTS or GSM) may be connected using a tunnel interface. The UE may register with the 3GPP CS network while on the LTE network by exchanging messages with the 3GPP CS core network over the tunnel interface. If a user makes a mobile originating (MO) call, or receives a mobile terminating (MT) call, the UE may inform the LTE network that the UE is leaving for the call by initiating a call setup procedure. However, there may be instances where the call setup procedure may fail. For example, the UE may not be moved to the 3GPP CS network, or the UE may be moved to the 3GPP CS network but the call may fail there. Therefore, certain aspects of the present disclosure provide techniques for providing an indication of the failed call to the user.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1× radio transmission technology (1×RTT), CDMA2000 1×, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM™, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs.

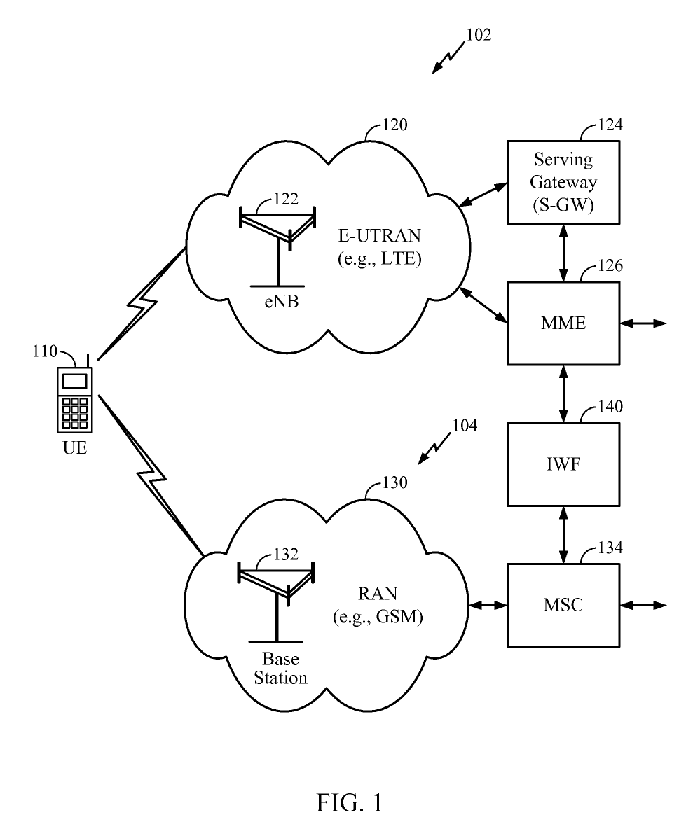

FIG. 1 shows an exemplary deployment in which multiple wireless networks have overlapping coverage. An evolved universal terrestrial radio access network (E-UTRAN) 120 may support LTE and may include a number of evolved Node Bs (eNBs) 122 and other network entities that can support wireless communication for user equipments (UEs). Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1×CSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1×RTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

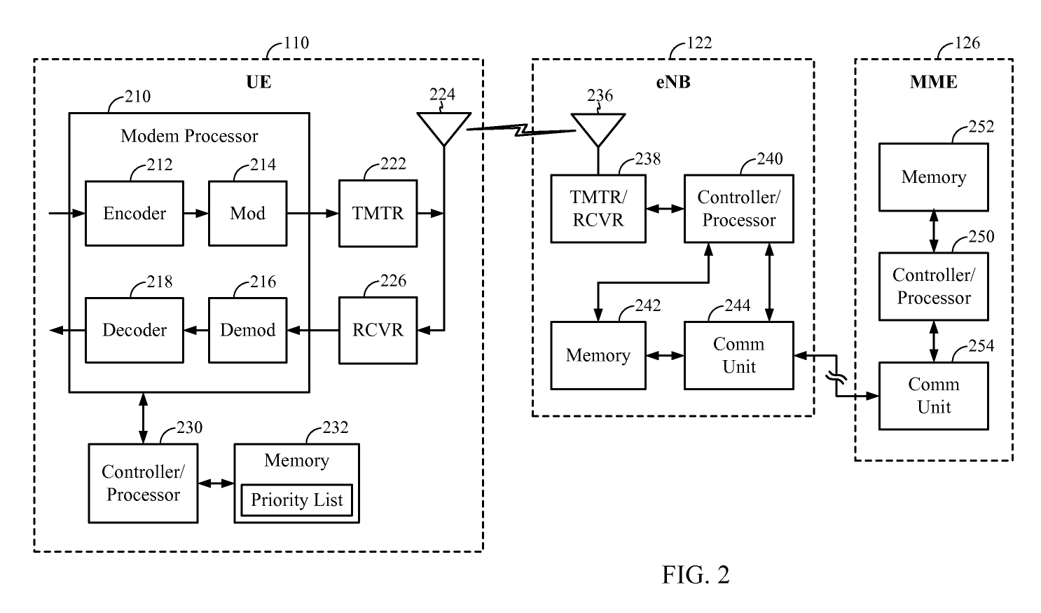

FIG. 2 shows a block diagram of a design of UE 110, eNB 122, and MME 126 in FIG. 1. At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 122.

On the downlink, antenna 224 may receive downlink signals transmitted by eNB 122 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210. These units may perform processing in accordance with the RAT (e.g., LTE, 133 RTT, etc.) used by the wireless network with which UE 110 is in communication.

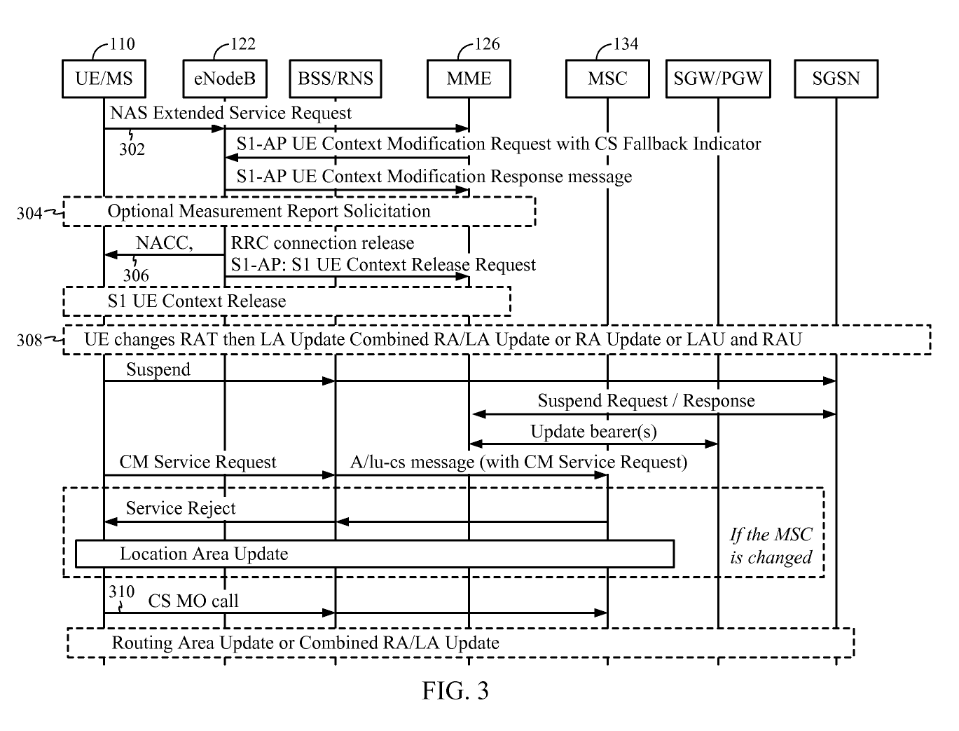

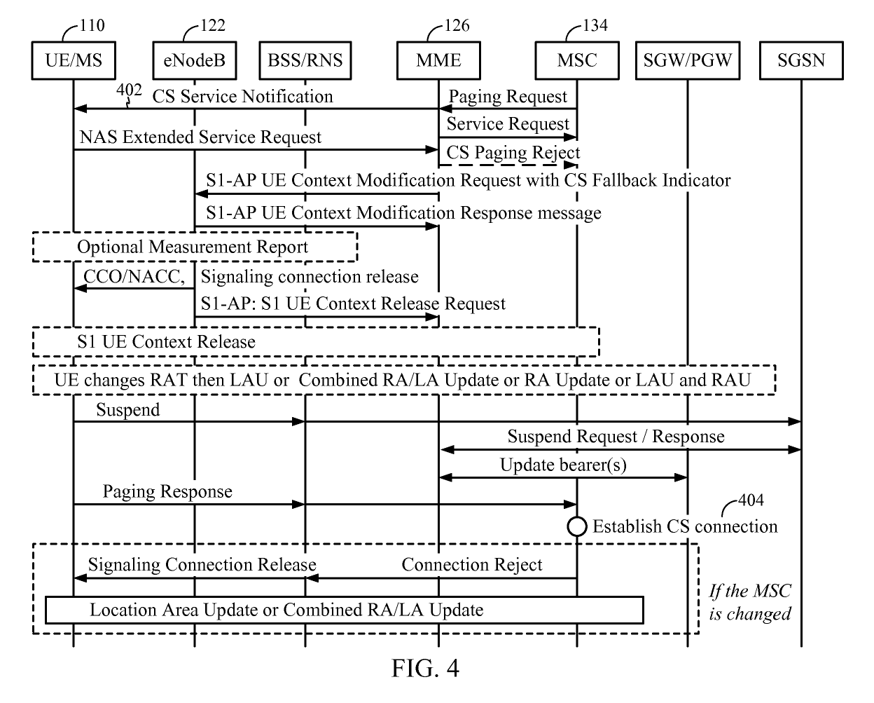

A controller/processor 230 may direct the operation at UE 110. Controller/processor 230 may also perform or direct other processes for the techniques described herein. Controller/processor 230 may also perform or direct the processing by UE 110 in FIGS. 3 and 4. Memory 232 may store program codes and data for UE 110. Memory 232 may also store a priority list and configuration information.

At eNB 122, a transmitter/receiver 238 may support radio communication with UE 110 and other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and other UEs. Controller/processor 240 may also perform or direct other processes for the techniques described herein. Controller/processor 240 may also perform or direct the processing by eNB 122 in FIGS. 3 and 4. Memory 242 may store program codes and data for the base station. A communication (Comm) unit 244 may support communication with MME 126 and/or other network entities.

At MME 126, a controller/processor 250 may perform various functions to support communication services for UEs. Controller/processor 250 may also perform or direct the processing by MME 126 in FIGS. 3 and 4. Memory 252 may store program codes and data for MME 126. A communication unit 254 may support communication with other network entities.

FIG. 2 shows simplified designs of UE 110, eNB 122, and MME 126. In general, each entity may include any number of transmitters, receivers, processors, controllers, memories, communication units, etc. Other network entities may also be implemented in similar manner.

FIG. 3 illustrates an example call flow of CSFB when a UE 110 makes a mobile originating (MO) call, according to certain aspects of the present disclosure. While the UE 110 is camped on an LTE network (eNB 122) that may not support voice services, the UE 110 may need to fallback to a GSM/UMTS network connected to the MSC 134 in order to make the MO call. The call setup procedure may begin at 302 where the UE 110 may send a non access stratum (NAS) extended service request (ESR) to the MME 126. The ESR may comprise a CSFB indicator that informs the MME 126 to perform CSFB. In response to the ESR, the MME 126 may indicate to the eNB 122 that the UE 110 should be moved to a GSM/UMTS network.

At 304, the eNB 122 may receive a measurement report from the UE 110 to determine CS RAT candidates to which the redirection procedure may be performed. At 306, the LTE network may assist the UE 110 in the mobility procedure (e.g., redirection, handover, or network assisted cell change (NACC)). For example, if an interface between the MSC 134 and the MME 126 is down, the LTE network may inform the UE 110 to retry the call setup after a set period of time. For some embodiments, the eNB 122 may trigger an inter-RAT cell change order with the NACC to a GSM cell by sending an RRC message to the UE 110. The inter-RAT cell change order may contain a CSFB indicator that indicates to the UE 110 that the cell change order is triggered due to a CSFB request.

At 308, the UE 110 may move to the new GSM cell, using, for example, the NACC information and establishing the radio signaling connection. At 310, the UE may initiate the CS MO call.

FIG. 4 illustrates an example call flow of CSFB when a UE 110 receives a mobile terminating (MT) call, according to certain aspects of the present disclosure. Operations may be similar to those described in FIG. 3, however, the UE 110 may initiate the call setup procedure after receiving a GSM/UMTS page at 402 (e.g., CS SERVICE NOTIFICATION). For example, the MSC 134 may receive an incoming voice call and respond by sending a paging request to the MME 126. The eNB 122 may forward the paging message to the UE 110. At 404, if the UE 110 is registered in the MSC 134 serving a GSM/UMTS cell, the MSC 134 may establish the CS MT call.

### Method And Apparatus For Improving Cell Redirection Search Time

In some cases, a UE camped on a first RAT network may be redirected to another RAT network. In such cases, considerable delay may be introduced while the UE attempts to acquire the second RAT network. Aspects of the present disclosure, however, may help mitigate this delay through an intelligent redirection approach.

As one example of redirection, in an LTE network, the network may, under some conditions, redirect a user equipment (UE) that may be camped on the LTE network from LTE to WCDMA or GSM for various reasons. One example of a reason for redirection is congestion on the LTE network side. Another example is the LTE network may not be capable of providing a particular service, for example, a voice call, as described above.

In such cases, such as circuit switched fallback (CSFB), the redirection search time may be critical-as increased delay can impact the user experience and, in some cases, may results in failure to establish the call.

In an effort to speed search time, a redirection message sent by the LTE network will include the frequency of a target cell (e.g., WCDMA or GSM cell). For example, the LTE network may have information about a suitable neighboring WCDMA cell. So in the redirection message to the UE, the LTE network may send the cell information and/or the frequency information of the WCDMA cell the UE is re-directed to.

However, the redirection message on LTE network may include only a single frequency. The search may not be successful using that frequency for a variety of reasons. For example, the network is not provisioned for that frequency. As another example, although the redirection message provides the target frequency information, the UE may be under temporary fade or even out of coverage of the target cell by the time redirection is triggered.

In any case, search time may be greatly increased, as some type of scanning may need to be employed to find a suitable cell for performing the call. Example embodiments of the present disclosure, however, provide techniques that may help reduce search time, even when a UE fails to find a suitable target cell based on an indicated frequency.

According to certain aspects, to find other WCDMA or GSM suitable cells, the UE may attempt acquisition on other frequencies than the frequency provided in the redirection message. One possible solution is for the UE to simply start full band scans (using desired scanning techniques) on WCDMA or GSM to find the first available frequency, however this would potentially take a long time due to the large number of possible frequencies. Further, the time taken to find the first available frequency may not be fixed. For example, in one instance the first available frequency may be the last band that is scanned, and in another instance the first available frequency may be on the first band that is scanned.

Thus, example embodiments of the present disclosure may be utilized as a relatively faster mechanism to quickly find a target cell after redirection, should acquisition on the one frequency provided in the redirection message fail. According to example embodiments, upon reception of (e.g., UTRA) redirection information in an RRC Connection release message, the following operations may be performed, to search for a cell using a heuristic approach.

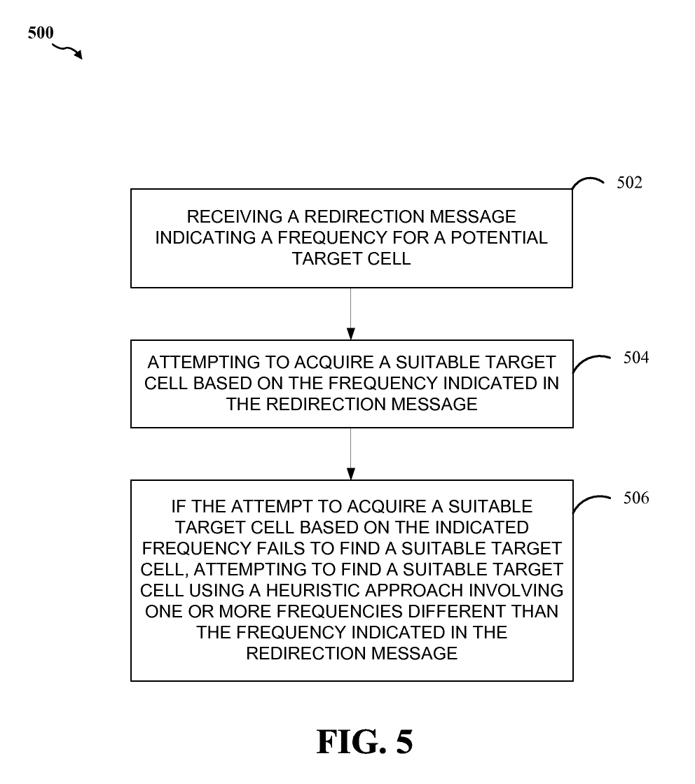

FIG. 5 illustrates example operations 500 performed during a redirection (e.g., from LTE to WCDMA or GSM), in accordance with certain aspects of the present disclosure.

The operations begin, at 502, by receiving a redirection message indicating a frequency for a potential target cell. At 504, the UE attempts to acquire a target cell based on the frequency indicated in the redirection message. At 506, if the attempt to acquire a target cell based on the indicated frequency fails to find a suitable target cell, the UE attempts to find a suitable target cell using a heuristic approach involving one or more frequencies different than the frequency indicated in the redirection message.

For the initial acquisition attempt, the UE may search for a suitable cell (suitable cell, pursuant to WCDMA, is a normal WCDMA cell selection criteria) on the target WCDMA or GSM frequency provided in the redirection message. In case an initial attempt to find a suitable target cell utilizing the frequency provided in the redirection message fails, the UE may continue to search the target cell multiple times (e.g., 2-3 times, or some type of configurable/programmable number of attempts). This mechanism provides a solution when, for instance, the UE is under temporary fade or out of coverage area of potential WCDMA cell.

According to certain aspects, if the UE successfully acquires the target cell, but determines that the cell is not suitable (e.g., to camp on), then the UE will not retry further on the same cell. It may continue acquisition attempts on other cells on the same frequency. Such cells may be obtained by a broadcast message such as SIB Type 5. In some cases, information regarding the unsuitability of this cell may be stored-so it is avoided or given lower priority in subsequent searches.

In any case, if a suitable target cell is not found using the frequency indicated in the redirection message, the UE may utilize a heuristic approach to efficiently search additional frequencies for a suitable cell. According to certain aspects, the UE may proceed to search different groups of frequencies that may likely correspond to suitable targets. For example, the group of frequencies may correspond to a set of cells that have been previously acquired. As another example, the group of frequencies may be for one or more neighbor cells obtained via a broadcast message (e.g., a SIB Type 6 message).

In this manner, the UE may efficiently search for a suitable cell using neighbor frequencies or frequencies of previously acquired cells. In some cases, the order in which the frequencies are searched may be determined in a strategic manner. For example, the acquisition may be attempted on these frequencies, for example, in the order of their received reference signal strength, which may determined from a power scan across all the frequencies in the group. During the power scan, pilot channel power check on all the neighbor frequencies (or other frequencies in the group) may be conducted.

In some cases, neighbor frequencies may be searched first, then previously acquired cells. For example, if there are no suitable cells available on the neighbor frequencies, the UE may then begin searching for the last acquired cells (e.g., using frequencies for the last 10 acquired cells) from a stored acquisition database. The database may be updated to store the frequencies of the WCDMA or GSM cells on which the UE most recently camped successfully.

If the UE is still not able to find a suitable cell, the UE may then start the full band scan (using desired scanning techniques) on WCDMA or GSM. In the example above, the UE may first search neighbor frequencies, then frequencies corresponding to previously acquired cells, then finally perform a global scan, if necessary. Of course, this order could also be reversed. In other words, the UE may first search one or more frequencies corresponding to previously acquired cells. If there are no suitable cells on such frequencies, the UE starts searching for one or more neighbor cells obtained by a broadcast message. Yet another option is to make a combined group of neighbor frequencies and frequencies of previously acquired cells and rank this combined list based on received reference signal strength.

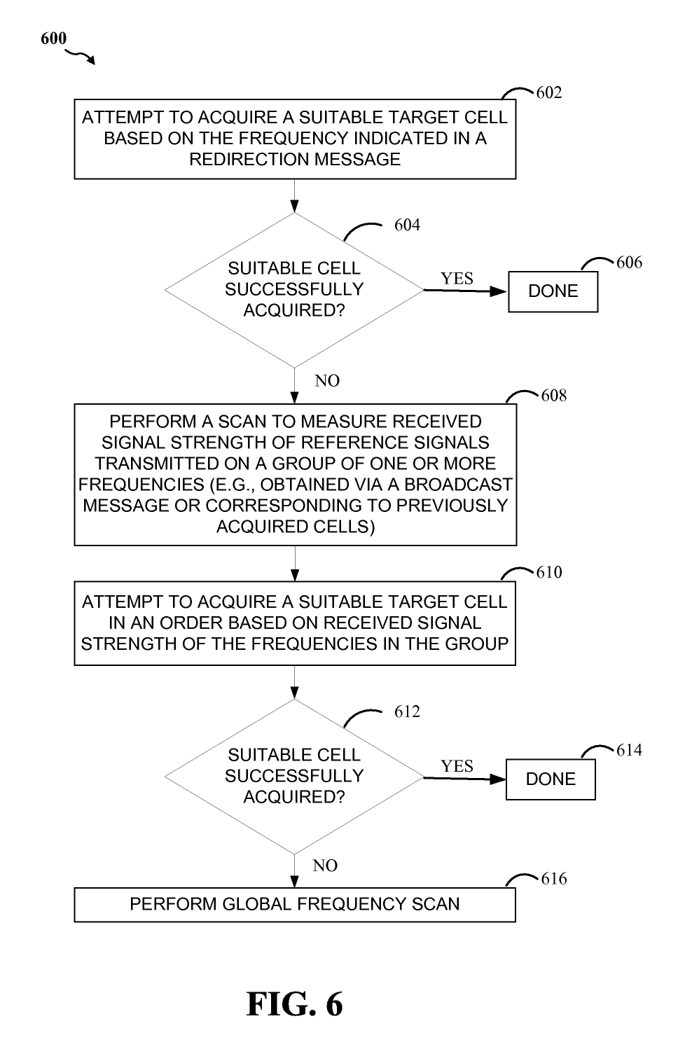

This approach is illustrated in FIG. 6. The example operations 600 that may be performed, for example, by a UE to perform a heuristic approach based on neighbor frequencies and/or frequencies of previously acquired cells, in the event acquisition based on a frequency provided in a redirection message fails.

The operations begin, at 602, by attempting to acquire a target cell based on the frequency indicated in a redirection message. If the attempt is successful, as determined at 604, the operations are terminated, at 606.

If a suitable cell is not acquired using the frequency indicated in the redirection message, the UE performs a scan to measure received signal strength of reference signals transmitted on a group of frequencies (e.g., obtained via a broadcast message or corresponding to previously acquired cells). At 610, the UE attempts to acquire a suitable target cell in an order based on the received signal strength of the frequencies in the group.

If the attempt is successful, as determined at 612, the operations are terminated, at 614. Otherwise, only after attempting the heuristic approach, a global scan may be performed, at 616.

One skilled in the art will recognize the potential advantage of the heuristic approaches provided by the example embodiments that, in case of a redirection failure, may allow the UE to find an alternate cell relatively faster as compared to when blindly scanning exhaustively for suitable WCDMA or GSM cells.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication by a user equipment (UE), comprising:
receiving a redirection message indicating a frequency for a potential target cell;
attempting to acquire a target cell based on the frequency indicated in the redirection message; and
if the attempt to acquire a target cell based on the indicated frequency fails to find a suitable target cell, attempting to find a suitable target cell using a heuristic approach involving one or more frequencies different than the frequency indicated in the redirection message.

2. The method of claim 1, wherein attempting to acquire a target cell based on the frequency indicated in the redirection message comprises:
attempting to acquire a suitable cell a predetermined number of times before declaring a failure and attempting to find a suitable target cell using the heuristic approach.

3. The method of claim 1, wherein an attempt to acquire a target cell based on a frequency is declared a failure if a cell is successfully acquired but a determination is made that cell is not suitable.

4. The method of claim 3, further comprising:
attempting to acquire another target cell based on the same frequency indicated in the redirection message after determining the successfully acquired cell is not suitable.

5. The method of claim 3, further comprising:
attempting acquisition of a suitable cell based on a next frequency after determining a successfully acquired cell is not suitable.

6. The method of claim 1, wherein the heuristic approach comprises:
performing a scan to measure received signal strength of reference signals transmitted on a group of one or more frequencies; and
attempting to acquire a suitable target cell based on the group of one or more frequencies in an order based on received signal strength of the reference signals.

7. The method of claim 6, wherein the group of one or more frequencies comprises a group of one or more neighbor frequencies obtained via a broadcast message.

8. The method of claim 6, wherein the group of one or more frequencies comprises a group of one or more frequencies corresponding to previously acquired cells.

9. The method of claim 7, wherein the group of one or more frequencies also comprises a group of one or more frequencies corresponding to previously acquired cells.

10. The method of claim 7, further comprising, if attempts to acquire a suitable target cell based on the group of one or more neighbor frequencies in an order based on received signal strength of the reference signals fail:
attempting to acquire a suitable target cell based on a group of one or more frequencies for previously acquired cells.

11. The method of claim 8, further comprising, if attempts to acquire a suitable target cell based on the group of one or more frequencies corresponding to previously acquired cells in an order based on received signal strength of the reference signals fail:
attempting to acquire a suitable target cell based on a group of one or more neighbor frequencies obtained via a broadcast message.

12. The method of claim 11, further comprising, if attempts to acquire a suitable target cell based on the group of one or more frequencies for previously acquired cells fail, attempting to acquire a suitable target cell based on a global frequency scan.

13. An apparatus for wireless communication by a user equipment (UE), comprising:
means for receiving a redirection message indicating a frequency for a potential target cell;
means for attempting to acquire a target cell based on the frequency indicated in the redirection message; and
means for attempting to find a suitable target cell using a heuristic approach involving one or more frequencies different than the frequency indicated in the redirection message if the attempt to acquire a target cell based on the indicated frequency fails to find a suitable target cell.

14. The apparatus of claim 13, wherein the means for attempting to acquire a target cell based on the frequency indicated in the redirection message comprises:
means for attempting to acquire a suitable cell a predetermined number of times before declaring a failure and attempting to find a suitable target cell using the heuristic approach.

15. The apparatus of claim 13, wherein an attempt to acquire a target cell based on a frequency is declared a failure if a cell is successfully acquired but a determination is made that cell is not suitable.

16. The apparatus of claim 15, further comprising:
means for attempting to acquire another target cell based on the same frequency indicated in the redirection message after determining the successfully acquired cell is not suitable.

17. The apparatus of claim 15, further comprising:
means for attempting acquisition of a suitable cell based on a next frequency after determining a successfully acquired cell is not suitable.

18. The apparatus of claim 13, wherein the heuristic approach comprises:
performing a scan to measure received signal strength of reference signals transmitted on a group of one or more frequencies; and
attempting to acquire a suitable target cell based on the group of one or more frequencies in an order based on received signal strength of the reference signals.

19. The apparatus of claim 18, wherein the group of one or more frequencies comprises a group of one or more neighbor frequencies obtained via a broadcast message.

20. The apparatus of claim 18, wherein the group of one or more frequencies comprises a group of one or more frequencies corresponding to previously acquired cells.

21. The apparatus of claim 19, wherein the group of one or more frequencies also comprises a group of one or more frequencies corresponding to previously acquired cells.

22. The apparatus of claim 19, further comprising means for attempting to acquire a suitable target cell based on a group of one or more frequencies for previously acquired cells, if attempts to acquire a suitable target cell based on the group of one or more neighbor frequencies in an order based on received signal strength of the reference signals fail.

23. The apparatus of claim 20, further comprising means for attempting to acquire a suitable target cell based on a group of one or more neighbor frequencies obtained via a broadcast message, if attempts to acquire a suitable target cell based on the group of one or more frequencies corresponding to previously acquired cells in an order based on received signal strength of the reference signals fail.

24. The apparatus of claim 23, further comprising attempting to acquire a suitable target cell based on a global frequency scan, if attempts to acquire a suitable target cell based on the group of one or more frequencies for previously acquired cells fail.

25. An apparatus for wireless communication by a user equipment (UE), comprising:
at least one processor configured to receive a redirection message indicating a frequency for a potential target cell, attempt to acquire a target cell based on the frequency indicated in the redirection message, and attempt to find a suitable target cell using a heuristic approach involving one or more frequencies different than the frequency indicated in the redirection message if the attempt to acquire a target cell based on the indicated frequency fails to find a suitable target cell; and
a memory coupled with the at least one processor.

26. The apparatus of claim 25, wherein the at least one processor is configured to:
attempt to acquire a suitable cell a predetermined number of times before declaring a failure and attempting to find a suitable target cell using the heuristic approach.

27. The apparatus of claim 25, wherein an attempt to acquire a target cell based on a frequency is declared a failure if a cell is successfully acquired but a determination is made that cell is not suitable.

28. The apparatus of claim 27, wherein the at least one processor is further configured to:
attempt to acquire another target cell based on the same frequency indicated in the redirection message after determining the successfully acquired cell is not suitable.

29. The apparatus of claim 27, wherein the at least one processor is further configured to:
attempt acquisition of a suitable cell based on a next frequency after determining a successfully acquired cell is not suitable.

30. The apparatus of claim 25, wherein the heuristic approach comprises:
performing a scan to measure received signal strength of reference signals transmitted on a group of one or more frequencies; and
attempting to acquire a suitable target cell based on the group of one or more frequencies in an order based on received signal strength of the reference signals.

31. A computer program product for wireless communication by a user equipment (UE), comprising a computer readable medium having instructions stored thereon, the instructions executable by one or more processors for:
receiving a redirection message indicating a frequency for a potential target cell;
attempting to acquire a target cell based on the frequency indicated in the redirection message; and
attempting to find a suitable target cell using a heuristic approach involving one or more frequencies different than the frequency indicated in the redirection message if the attempt to acquire a target cell based on the indicated frequency fails to find a suitable target cell.

32. The computer program product of claim 31, wherein attempting to acquire a target cell based on the frequency indicated in the redirection message comprises:
attempting to acquire a suitable cell a predetermined number of times before declaring a failure and attempting to find a suitable target cell using the heuristic approach.

33. The computer program product of claim 31, wherein an attempt to acquire a target cell based on a frequency is declared a failure if a cell is successfully acquired but a determination is made that cell is not suitable.

34. The computer program product of claim 33, wherein the instructions are further executable for:
attempting to acquire another target cell based on the same frequency indicated in the redirection message after determining the successfully acquired cell is not suitable.

35. The computer program product of claim 33, wherein the instructions are further executable for:
attempting acquisition of a suitable cell based on a next frequency after determining a successfully acquired cell is not suitable.

36. The computer program product of claim 31, wherein the heuristic approach comprises:
performing a scan to measure received signal strength of reference signals transmitted on a group of one or more frequencies; and
attempting to acquire a suitable target cell based on the group of one or more frequencies in an order based on received signal strength of the reference signals.
